(19) United States
(12) Patent Application Publication
(10) Pub. No.: US 2004/0245218 A1
(43) Pub. Date: Dec. 9, 2004

(54) Method for fabricating a light guide plate mold and a light guide plate

(76) Inventor: Ga-Lane Chen, Fremont, CA (US)

Correspondence Address: WEI TE CHUNG, FOXCONN INTERNATIONAL, INC., 1650 MEMOREX DRIVE, SANTA CLARA, CA, 95050, US

(21) Appl. No.: 10/862,075

(22) Filed: Jun. 3, 2004

(30) Foreign Application Priority Data
Jun. 3, 2003 (TW) 92115121

(51) Int. Cl. F21V 7/04; B28B 1/00

(52) U.S. Cl. 216/96; 264/645

(57) ABSTRACT

A method for fabricating a mold for a light guide plate in accordance with the present invention generally includes the following steps: providing a substrate (18); and providing electron beams (15) to etch the substrate according to predetermined patterns. Because a focus diameter of the electron beams is adjustable, a very narrow line-width of the patterns can be obtained by employing the fine focus diameter of the electron beams. That is, the mold (18′) fabricated by the present invention can have fine patterns at the nanoscale level. The light guide plate (22) formed using the mold has correspondingly fine patterns. These fine patterns can greatly enhance the quality and performance of the light guide plate.

### BACKGROUND OF THE INVENTION

1. Field of the Invention

The present invention relates to methods for fabricating light guide plates and molds used in such fabrication, and more particularly to a method for fabricating a light guide plate mold having fine patterns and a corresponding light guide plate.

2. Description of Prior Art

A liquid crystal display is capable of displaying a clear and sharp image through a plurality of tiny image elements known as pixels. It has thus been applied to various electronic equipment in which messages or pictures need to be displayed, such as in mobile phones and notebook computers. However, liquid crystals in the liquid crystal display do not themselves emit light. Rather, the liquid crystals have to be lit up by a light source so as to clearly and sharply display text and images. The light source may be ambient light, or part of a backlight system attached to the liquid crystal display.

A conventional backlight system generally comprises a plurality of components, such as a light source, a reflective plate, a light guide plate, a diffusion plate and a prism layer. Among these components, it is generally believed that the light guide plate is the most crucial one in determining the performance of the backlight system. The light guide plate serves as an instrument for receiving light beams from the light source, and for evenly distributing the light beams over the entire surface of the light guide plate through reflection and diffusion. In order to keep light evenly distributed over an entire surface of the associated liquid crystal display, the diffusion plate is generally arranged on top of the light guide plate.

Conventionally, there are two important kinds of methods for fabricating a light guide plate: printing processes and non-printing processes. In a typical printing process, marks are coated on a bottom surface of a transparent plate, so as to form an array of dots that can scatter and reflect incident light beams. The dots can totally eliminate internal reflection of the light beams, and make the light beams evenly emit from a light emitting surface of the transparent plate. However, the precision of the printing process is difficult to control, and printing processes are gradually being replaced by non-printing processes.

Among non-printing processes, methods commonly used for fabricating a mold for a light guide plate include chemical etching, laser scoring, and precise mechanical scoring. However, the patterns formed on the light guide plate have a precision at the micron level only. Said methods cannot achieve the higher precision desired by light guide plate manufacturers.

### SUMMARY OF THE INVENTION

It is therefore an objective of the present invention to provide a method for fabricating a mold for a light guide plate, the mold having fine patterns.

Another objective of the present invention is to provide a method for fabricating a light guide plate having fine patterns.

In order to achieve the first above-mentioned objective, a method for fabricating a mold for a light guide plate having fine patterns includes the following steps: providing a substrate; and providing electron beams to etch the substrate according to predetermined patterns.

In order to achieve the second above-mentioned objective, a method for fabricating a light guide plate includes the following steps: providing a substrate; providing electron beams to etch the substrate to form a mold having predetermined patterns; forming the light guide plate using said mold; and demolding to release the light guide plate.

Because a focus diameter of the electron beams is adjustable, a very narrow line-width of the patterns can be obtained by employing a fine focus diameter of the electron beams. That is, the mold fabricated by the present invention can have fine patterns at the nanoscale level. The light guide plate formed using the mold has correspondingly fine patterns. These fine patterns can greatly enhance the quality and performance of the light guide plate.

Other objects, advantages, and novel features of the present invention will become more apparent from the following detailed description when taken in conjunction with the accompanying drawings, in which:

### BRIEF DESCRIPTION OF THE DRAWINGS

FIG. 1 is a flow chart of the method for fabricating a mold according to the present invention;

FIG. 2 is a schematic plan view of a vacuum cavity in which a substrate is etched by electron beams according to the present invention;

FIG. 3 is an enlarged, cross-sectional view of part of a surface of the substrate of FIG. 2 duly etched, said etched substrate constituting the mold fabricated according to the present invention;

FIG. 4 is a schematic, cross-sectional view of a cover mold combined with the mold fabricated according to the present invention, in accordance with the method for fabricating a light guide plate according to the present invention; and

FIG. 5 is similar to FIG. 3, but also showing a corresponding part of the light guide plate fabricated according to the present invention.

### DETAILED DESCRIPTION OF THE INVENTION

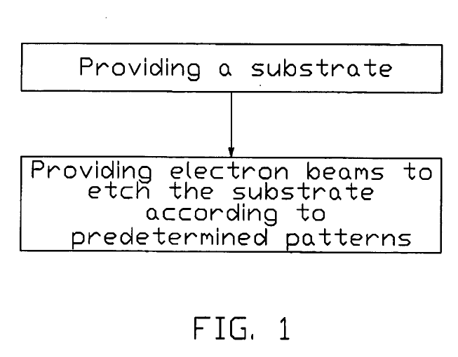

Referring to FIG. 1, a method for fabricating a mold for a light guide plate in accordance with the present invention comprises the following steps:

First, a substrate is provided. The substrate is generally made of a high temperature resistant material, such as silicon carbide, silicon nitride, ceramic material or glass.

Second and finally, electron beams are provided to etch the surface of the substrate according to a predetermined pattern in a vacuum.

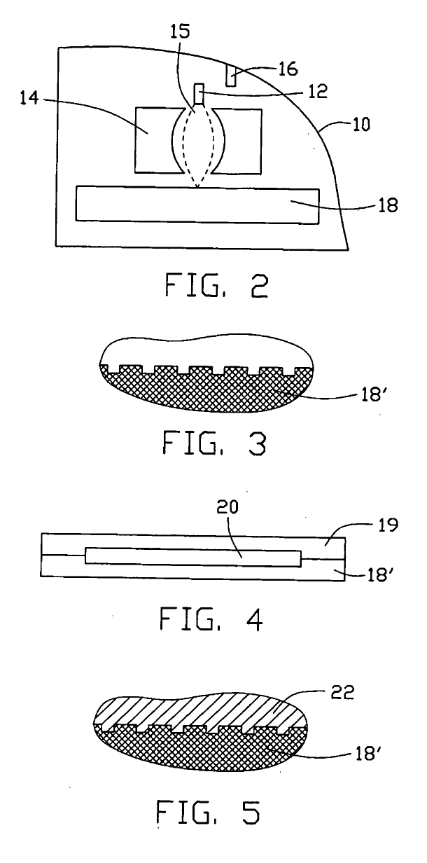

Referring to FIG. 2, a vacuum cavity 10 is provided. An air pressure of the vacuum cavity 10 is less than 7×10−4 pascal. An electron emitter 12 is mounted in the vacuum cavity 10. The electron emitter 12 is a ZrO/W electron emitter, and can emit electron beams 15 when electrified. An accelerating electric field (not shown) is provided to accelerate the electron beams 15. A voltage of the accelerating electric field is 20 KV˜50 KV. An electromagnetic lens 14 is provided to focus the electron beams 15. A sensor 16 is used to detect secondary electrons which are released from the substrate 18 when the electron beams 15 bombard the substrate 18. The sensor 16 scans the substrate 18 according to the various wavelengths of the secondary electrons.

The electron beams 15 emitted from the electron emitter 12 bombard the surface of the substrate 18. The kinetic energy of electrons in the electron beams 15 is transformed into heat energy that can melt the surface of the substrate 18. Thus, the electron beams 15 etch patterns on the surface of the substrate 18. The electromagnetic lens 14 can adjust a focus diameter of the electron beams 15 by adjusting current loops and current levels. In general, a rough focus diameter of the electron beams is less than 100 nanometers, a medium focus diameter is less than 20 nanometers, and a fine focus diameter is less than 2 nanometers. A minimum line-width of the electron beam etching is 10 nanometers; that is, the patterns of the mold can be formed with extremely high precision.

Referring to FIG. 3, patterns are formed on the substrate 18 as a result of the electron beam etching. The patterns have a line-width of 10 nanometers when electron beams having the fine focus diameter are used. The resulting substrate 18′ having these fine patterns constitutes the mold fabricated in accordance with the present invention.

Referring to FIG. 4, a method for fabricating a light guide plate using the substrate 18′ is performed as follows. A cover mold 19 is placed on the substrate 18′. A cavity 20 is thus formed between the upper mold 19 and the substrate 18′. An inner main surface of the cover mold 19 is smooth, while a surface of the substrate 18′ opposite to said inner main surface has the fine patterns. A light transmissive material, such as synthetic resin, is injected into the cavity 20. Then, a light guide plate 22 having fine patterns is formed by emboss injection molding (see FIG. 5).

Finally, the cover mold 19 and the substrate 18′ are demolded in order to release the fabricated light guide plate 22.

Referring to FIG. 5, the light guide plate 22 has fine patterns corresponding to the fine patterns of the substrate 18′. A precision of the patterns of the light guide plate 22 is equal to the precision of the patterns of the substrate 18′. That is, the patterns of the light guide plate 22 have a minimum line-width of 10 nanometers.

Since the focus diameter of the electron beams 15 is adjustable, a very narrow line-width of the patterns can be obtained by employing the fine focus diameter of the electron beams 15. That is, the mold fabricated by the present invention can have fine patterns at the nanoscale level. The light guide plate 22 formed using the mold has correspondingly fine patterns. These fine patterns can greatly enhance the quality and performance of the light guide plate 22.

It is to be understood that even though numerous characteristics and advantages of the present invention have been set out in the foregoing description, together with details of the steps and function of the invention, the disclosure is illustrative only, and changes may be made in detail, especially in matters of arrangement of steps within the principles of the invention to the full extent indicated by the broad general meaning of the terms in which the appended claims are expressed.

I claim:

1. A method for fabricating a mold for a light guide plate, comprising:
providing a substrate; and
providing electron beams to etch the substrate according to predetermined patterns.

2. The method for fabricating a mold for a light guide plate as recited in claim 1, wherein the electron beam etching is performed in a vacuum.

3. The method for fabricating a mold for a light guide plate as recited in claim 2, wherein an air pressure of the vacuum is less than 7×10⁻⁴ pascal.

4. The method for fabricating a mold for a light guide plate as recited in claim 1, wherein the substrate is made of silicon carbide, silicon nitride, ceramic material or glass.

5. The method for fabricating a mold for a light guide plate as recited in claim 1, wherein an emitter of the electron beams is a ZrO/W electron emitter.

6. The method for fabricating a mold for a light guide plate as recited in claim 1, wherein an accelerating voltage of the electron beams is 20 KV˜50 KV.

7. The method for fabricating a mold for a light guide plate as recited in claim 1, wherein a focus diameter of the electron beams is less than 100 nanometers.

8. The method for fabricating a mold for a light guide plate as recited in claim 7, wherein the focus diameter of the electron beams is less than 20 nanometers.

9. The method for fabricating a mold for a light guide plate as recited in claim 8, wherein the focus diameter of the electron beams is less than 2 nanometers.

10. A method for fabricating a light guide plate, comprising:
providing a substrate;
providing electron beams to etch the substrate according to predetermined patterns to form a mold;
forming the light guide plate using said mold; and
demolding to release the light guide plate.

11. The method for fabricating a light guide plate as recited in claim 10, wherein the electron beam etching is performed in a vacuum.

12. The method for fabricating a light guide plate as recited in claim 11, wherein an air pressure of the vacuum is less than 7×10⁻⁴ pascal.

13. The method for fabricating a light guide plate as recited in claim 10, wherein the substrate is made of silicon carbide, silicon nitride, ceramic material or glass.

14. The method for fabricating a light guide plate as recited in claim 10, wherein an emitter of the electron beams is a ZrO/W electron emitter.

15. The method for fabricating a light guide plate as recited in claim 10, wherein an accelerating voltage of the electron beams is 20 KV˜50 KV.

16. The method for fabricating a light guide plate as recited in claim 10, wherein a focus diameter of the electron beams is less than 100 nanometers.

17. The method for fabricating a light guide plate as recited in claim 16, wherein the focus diameter of the electron beams is less than 20 nanometers.

18. The method for fabricating a light guide plate as recited in claim 17, wherein the focus diameter of the electron beams is less than 2 nanometers.

19. The method for fabricating a light guide plate as recited in claim 10, wherein the step of forming the light guide plate using said mold comprises emboss injection molding.

20. The light guide plate made from the method as defined in claim 10.
